(19) United States
(12) Patent Application Publication
(10) Pub. No.: US 2003/0201974 A1
(43) Pub. Date: Oct. 30, 2003

(54) Apparatus display

(76) Inventor: Memphis Zhihong Yin, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/133,543

(22) Filed: Apr. 26, 2002

(51) Int. Cl. G09G 5/08

(52) U.S. Cl. 345/158

(57) ABSTRACT

A display for an apparatus. An OLED display, capable of displaying a first display viewable at a first surface and a second display viewable at a second-surface, responds to a detector to display either the first or the second display. The detector may determine whether to display the first or the second display depending on a position of all or a portion of the apparatus.

### FIELD OF THE INVENTION

The present invention relates generally to the field of displays and/or controls for various types of apparatuses.

### BACKGROUND OF THE INVENTION

Apparatuses, such as computers, peripherals, portable equipment, and others, may include displays for providing information to a user. This information may be, among other things, an indication of the operating status of the apparatus, or information collected, recorded, or processed by the apparatus (for example, a view screen for a portable camera). The display may also be part of a control for operating an apparatus.

However, a display or control for an apparatus may not be easily viewable or available to a user when the user moves the apparatus or a portion of the apparatus. For example, an apparatus or a portion of the apparatus may be usable in a number of positions. These positions may be locations, orientations, open or closed states, or others. However, displays or controls for such an apparatus may be sufficiently viewable only when the apparatus or a portion thereof is in a particular position. If a user wishes to view the display or operate the controls, he or she may need to reposition all or a portion of the apparatus so that the display and/or controls are viewable and/or accessible. This is often inconvenient for the user, particularly when the apparatus, to be operated as the user desires, must be in a position that does not allow viewing of the display.

### SUMMARY OF THE INVENTION

A display for an apparatus has an organic light emitting diode (OLED) display that is capable of selectively producing either a first display viewable at a first surface of the apparatus or a second display viewable at a second surface of the apparatus. A detector determines which of the first or second displays should be produced, and the OLED display responds to the detector to produce one of the first display or the second display. Preferably, the detector determines whether the first or the second display should be produced depending on whether the apparatus or a portion thereof is in a first position or a second position.

### BRIEF DESCRIPTION OF THE DRAWINGS

FIG. 1A is a perspective view of a portable computer having a display according to a first preferred embodiment of the present invention, with the portable computer in an open position;

FIG. 1B is an enlarged fragmentary view of the portable computer of FIG. 1A, with the portable computer in an open position;

FIG. 2 is an enlarged fragmentary view of the portable computer and display shown in FIG. 1B, with the portable computer in a closed position;

FIG. 3 is an exploded perspective view of a preferred embodiment display;

FIG. 4 is a block diagram of a display for an apparatus according to a preferred embodiment of the present invention;

FIG. 5 is a perspective view of a camera in a first location having a display according to a second preferred embodiment of the present invention;

FIG. 6 is a perspective view of the camera shown in FIG. 5, with the camera in a second location; and

FIG. 7 is a flowchart showing a method of operation of the display according to an embodiment of the present invention.

### DETAILED DESCRIPTION OF THE INVENTION

The present invention provides a display for an apparatus, which has at least first and second surfaces in first and second planes, respectively. The display includes an OLED display configured to selectively produce a first display viewable at the first surface of the apparatus, or a second display viewable at the second surface of the apparatus, in response to a detector. In a preferred embodiment, the detector determines whether the first display or the second display is shown based on whether the apparatus or a portion thereof is in a first position or a second position.

In this way, the OLED display can produce a display in a location that better suits the viewing angle of the user when the apparatus or a portion thereof is moved from one position to another. The OLED display may be capable of multiple displays with relatively low production costs. In addition, in a preferred embodiment, the OLED display may display controls that a user can access from multiple locations, with preferably lower production costs than that needed to produce sets of fixed controls.

The invention will now be illustrated with respect to preferred embodiment displays and representative apparatuses incorporating the preferred embodiment displays. In describing the invention, particular exemplary apparatuses and apparatus applications will be used for purposes of illustration. Dimensions and illustrated apparatuses may be exaggerated for purposes of illustration and understanding of the invention.

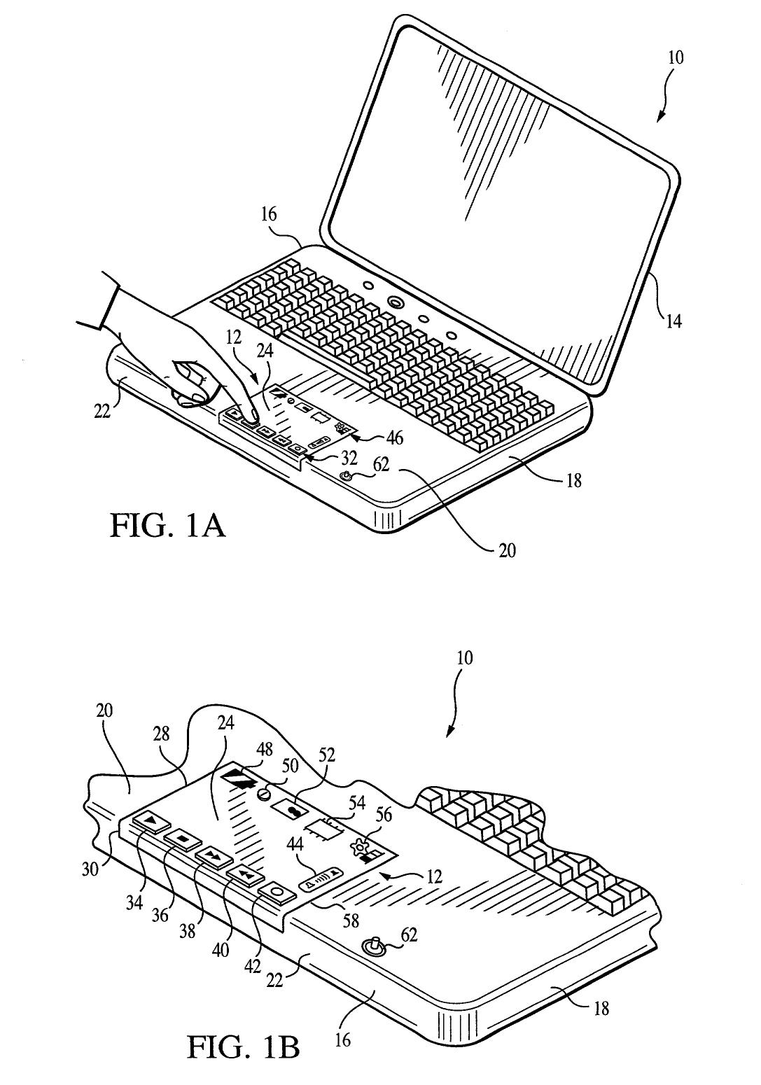

Referring now to the drawings, FIGS. 1A and 1B show an apparatus, such as a portable computer 10, having an OLED display 12 according to a first embodiment of the present invention, with the portable computer 10 in an open position. The portable computer 10 has a screen 14 rotatably connected to a base 16. A housing 18 substantially surrounds both the screen 14 and the base 16. The portable computer 10 includes a number of surfaces, including a first surface 20 and a second surface 22, which are in first and second planes, respectively. As shown in FIGS. 1A and 1B, for example, the first surface 20 and the second surface 22 are oriented approximately 90 degrees from one another, though a 90 degree angle is not necessary. The first surface 20 and the second surface 22 may also be parallel to one another in certain embodiments, for example, they may be inwardly and outwardly facing surfaces.

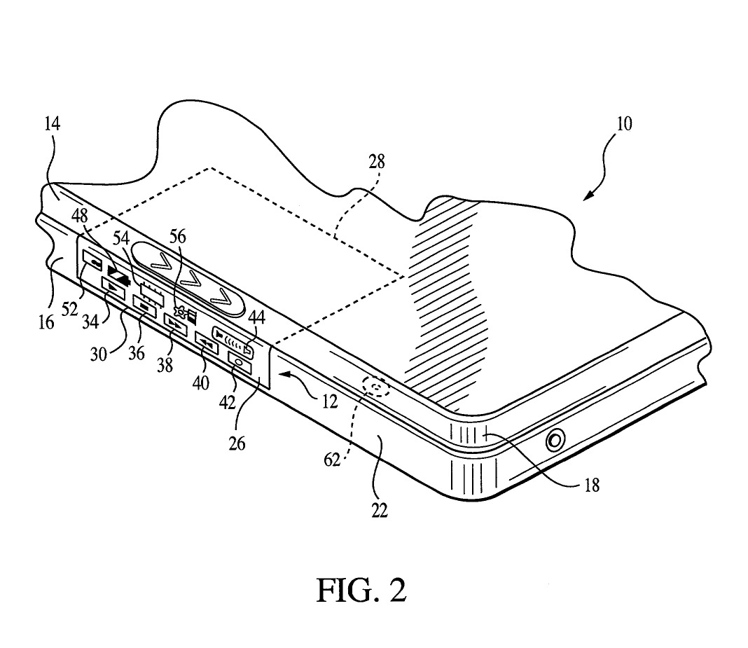

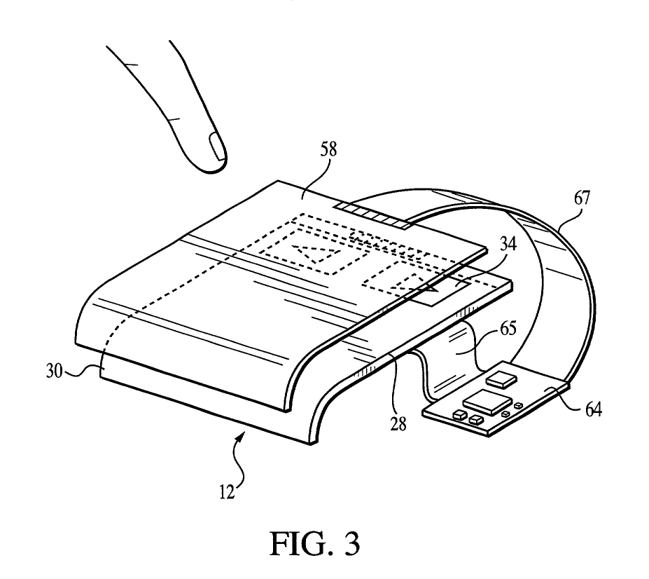

The OLED display 12 in the first preferred embodiment is provided for the portable computer 10 as an interface for controlling playback from a disk drive (not shown), such as a CD drive, and for indicating the status of the disk drive or other parts of the portable computer. Instead of, or in addition to, controlling a disk drive, however, the OLED display 12 may be used for viewing information and/or controlling various other components of the portable computer 10. The OLED display 12 is positioned on and/or within the portable computer 10 and configured to produce a first display 24 viewable at the first surface 20 and a second display 26 (see FIG. 2) viewable at the second surface 22 of the portable computer. For example, the OLED display 12 shown in FIGS. 1A-1B and 2-3 has a “waterfall” shape (best seen in FIG. 3), and extends from the first surface 20 to the second surface 22. In a preferred embodiment, the OLED display 12 is a flexible OLED (FOLED) display.

In a preferred configuration, the OLED display 12 illuminates a first portion 28 of the OLED display viewable at the first surface 20 of the portable computer 10 to produce the first display 24 (FIGS. 1A and 1B), and illuminates a second portion 30 viewable at the second surface 22 to produce the second display 26 (FIG. 2). The OLED display 12 may, but need not, be disposed at or on the first surface 20 or second surface 22 to produce displays viewable at these surfaces. For example, the OLED display 12 may be disposed underneath the surfaces 20, 22, or it may be positioned away from the surfaces while illuminations are viewable at the surfaces (reflected, for example). In addition, the OLED display 12 is not required to extend continuously from the first surface 20 to the second surface 22 as shown in FIGS. 1A-3, but instead may, for example, extend entirely or partially underneath the first and second surfaces (through the housing 18), so that peripheral portions of the OLED display are viewable at the first and second surfaces, while a central portion of the display is obstructed by the housing. Portions of the housing 18 may be selectively transparent as well, so that all or selected portions of the OLED display 12 are viewable by the user.

The first display 24 produced by the example OLED display 12 shown in FIGS. 1A and 1B, and viewable at the first surface 20 of the portable computer 10, contains a number of control icons 32 that include symbols for control functions of the disk drive. The control icons 32 contained in the first display 24 are preferably controls that would be useful for a user when the portable computer 10 is open. The control icons 32 may include, for example, a play icon 34, a stop icon 36, a forward icon 38, a reverse icon 40, a power icon 42, and a volume control icon 44. In addition, the preferred first display 24 displays a number of status icons 46, which indicate operating status or other information for the disk drive or other components of the portable computer 10. The status icons 46 may include, but are not limited to, a battery indicator icon 48, a hard disk status icon 50, a disk drive status icon 52, a memory status icon 54, and a CPU speed status icon 56. The control icons 32 and the status icons 46 need not be in separate locations, as shown in FIG. 1A, for example, but may instead be interposed with one another.

Referring now to FIG. 2, the OLED display 12 is shown producing the second display 26 viewable at the second surface 22 of the portable computer 10. The second display 26 preferably includes elements also present in the first display 24. In the example shown in FIG. 3, the second display 26 includes the disk drive status icon 52, the battery status icon 48, the memory status icon 54, the CPU status icon 56, and the power icon 42, in addition to the volume control icon 44, the play icon 34, the stop icon 36, the forward icon 38, and the reverse icon 40, all of which are also present in the first display 24. The icons selected to be in the second display 26 are preferably those that would be most useful to a user when the portable computer 10 is closed, for example, to play a music CD or view the power status of the portable computer. Although the second display 26 need not include any of the specific elements present in the first display 24, providing the same or similar elements to those in the first display allows a user to view information and access controls that are consistent between the first surface 20 and the second surface 22. If icons are shown in the second display 26, they need not be identical to corresponding ones of the first display 24; for example, they may have partially different configurations. Preferably, though, there is some similarity between the information and/or controls provided on the first display 24 and the second display 26. This also allows the control icons 32 or status icons 46 to appear to “shift” from the first display 24 to the second display 26, or vice versa. In an alternative embodiment, the OLED display 12 produces more than two displays, and thus an image may “shift” through a number of displays.

Preferably, the OLED display 12 includes a number of pixels (picture elements) that may be illuminated to produce the first display 24 or the second display 26. Most preferably, the pixels substantially cover the first portion 28 and the second portion 30 of the OLED display 12. The illuminated pixels of the first display 24 shown in FIGS. 1A-1B are disposed at the first portion 28 of the OLED display 12 viewable from the first surface 20. The illuminated pixels of the second display 26 shown in FIG. 2 are disposed at the second portion 30 of the OLED display 12 viewable from the second surface 22. Thus, by illuminating the pixels at the first portion 28 or the second portion 30 of the display 12, the OLED display produces the first display 24 viewable at the first surface 20 or the second display 26 viewable at the second surface 22, respectively. By selectively illuminating the icons at the first 28 or second portions 30, the icons can appear to shift from one surface to the other. The OLED display may be a passive or active matrix display.

As will be appreciated by those in the art, the pixels can be illuminated in patterns to form the control icons 32 or the status icons 46. While the pixels preferably are disposed over the entire OLED display 12, alternatively the pixels may be present only in the location of the displays 24, 26 to be produced. For example, both the first portion 28 and the second portion 30 of the OLED display 12 may contain picture or light elements disposed under and/or beside a transparent or translucent plastic overlay having two sets of printed icons. In this alternative embodiment, one set may be disposed over the first portion 28, and another set may be disposed over the second portion 30. Other methods or configurations for displaying first 24 and second displays 26 may be used with the present invention.

In a preferred embodiment of the present invention, and as shown most clearly in FIG. 3, an input device 58 such as, but not limited to, a translucent or transparent touch-sensitive membrane, is disposed partially or entirely over the OLED display 12. The touch-sensitive membrane preferably is configured so that the membrane detects an input location, which is a location of pressure applied to the membrane. Preferably, the touch-sensitive membrane is integrated with the OLED display 12 so that the user can interface with the display by contacting the input device 58 at locations over or otherwise near or analogous to the location of the displayed control icons 32 shown on the OLED display. For example, the user may touch a portion of the input device 58 disposed over the play icon 34 to cause the disk drive to play a disk. Instead of a touch-sensitive membrane, the input device 58 may include hard keys, which are selectively illuminated by the OLED display 12. In a contemplated embodiment, the OLED display 12 may be integrated with a membrane of the type common in portable computers.

Referring again to FIGS. 1A-1B and 2, a detector 62 is provided for determining whether the OLED display 12 produces the first display 24 or the second display 26. A suitable detector may be any hardware or software device capable of having two or more states or producing two or more different outputs so that the OLED display 12, which is responsive to the detector directly or indirectly, can display the first 24 or the second display 26 based at least partly on the output of the detector.

For example, and as shown in FIGs. 1A-1B and 2, the detector 62 may be a switch, such as a push-button switch, which is depressed by rotation of the screen 14 towards the base 16, for example, when closing the portable computer 10. As is well known in the art, the screen 14 of the portable computer 10 rotates away from or towards the base 16 to place the portable computer in an open position or a closed position. These positions are relative, as the portable computer 10 can be either “open” or “closed” within various angles between the screen 14 and the base 16. Thus, opening or closing the portable computer 10 moves the push-button switch of the detector 62 to a first (for example, raised) or second (lowered) position. The positions of the detector 62 may be relative.

The type and location of the detector 62 may vary. For example, the detector 62 may be disposed near the front of the base 16, or may be disposed in an alternate location such as the rear of the base. Detectors 62 in the form of switches that are responsive to lowering the screen 14 to place the computer into a “suspend” mode may also be used to detect an open or closed position of the portable computer 10.

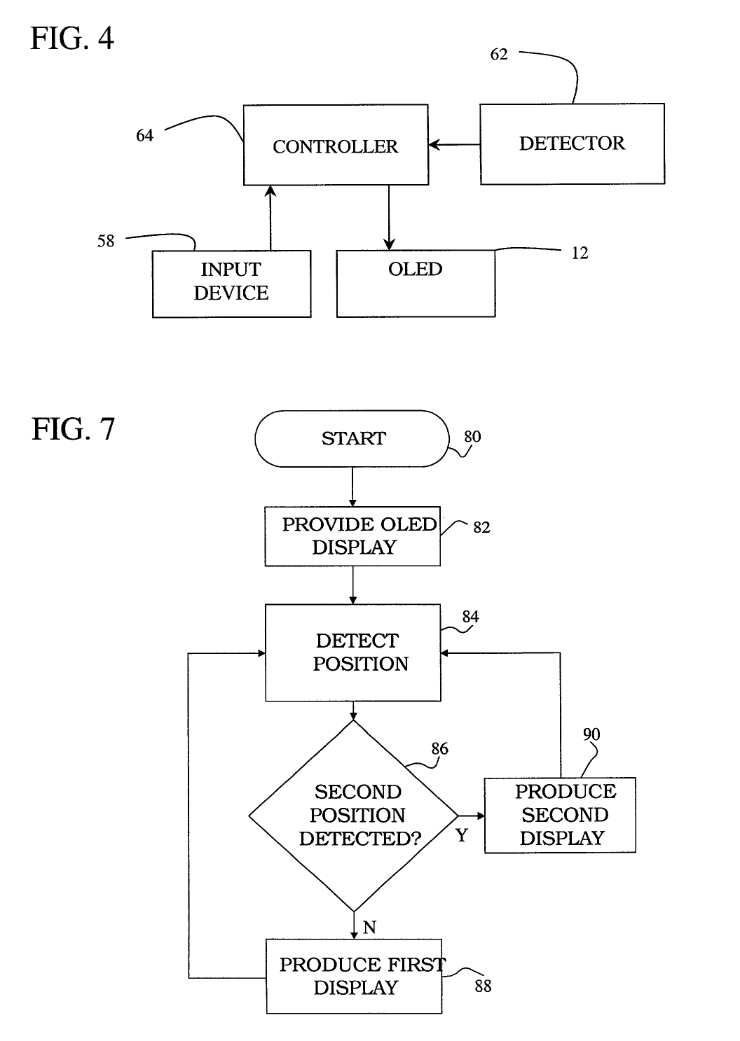

FIG. 4 shows a preferred arrangement of components of the display. The components of the display may be integrated into an apparatus using any suitable method. The detector 62 may be coupled to a controller 64, such as a processor (for example, the CPU of the portable computer 10 or other processing device, running appropriate software, or firmware, as necessary) or other device for controlling the OLED display 12. Alternatively, the detector 62 may be connected directly to the OLED display 12. In the configuration shown in FIG. 4, the controller 64 receives a signal from the detector 62 and controls the OLED display 12 for producing the first display 24 or the second display 26.

The controller 64 may also be connected to the input device 58 for receiving information, such as when the OLED display 12 displays the control icons 32. The connection between the controller 64 and the input device 58 may be direct, such as via a flex cable 65 or other link, or indirect, such as through the OLED display 12. The OLED display 12 may connect to the controller 64 directly via a second flex cable 67, or in other ways. If the input device 58 is a touch-sensitive membrane that detects an input location, the controller 64 preferably analyzes the detected input location. By comparing the input location to a known location, preferably a location correlating to the location of an icon in the OLED display 12, the controller 64 can determine whether a particular control was selected by the user.

FIG. 7 shows an operation of the display according to one embodiment of the invention. When the display operation begins (step 80), the OLED display 12 is provided (step 82), and the detector 62 detects a position of all or a portion of the apparatus 10 (step 84), preferably based on the state of the detector. Responding to the output or state of the detector 62 (step 86), the OLED display 12 produces the first display 24 (step 88) or the second display 26 (step 90). In the exemplary process shown, it is determined if the second position was detected by the detector 62 (step 86). In the embodiment of the present invention shown in FIGS. 1A, 1B, and 2, this occurs when the portable computer 10 is closed, depressing the detector 62. If so, the OLED display 12 produces the second display 26 (step 90) and returns to the detection step (step 84). If the detector 62 is not in the second position, as is true when the portable computer 10 is in the open position detected by the detector 62 being in the raised position, the OLED display 12 produces the first display 24 (step 88) and returns to the detection step (step 84). In a preferred embodiment of the invention, the controller 64 determines (step 86) whether the detector 62 detects the second position, and causes the OLED display 12 to produce either the first or second display 24, 26 accordingly (steps 88, 90).

Variations of the exemplary process shown in FIG. 7 are possible. For example, in the exemplary process, the first display 24 is a default display. However, in other contemplated embodiments, the second display 26 may be a default, the default may be set according to specific conditions (for example, the last display produced may be set as a default), or no default may be set at all, in which case the OLED display 12 may wait to produce a display until, for example, the detector 62 is in a particular state or states. In addition, the exemplary process shown in FIG. 7 produces the first and second displays 24, 26. However, in other possible embodiments, more than two displays are possible, and a similar method to that shown in FIG. 7 may be used to select and produce particular displays. Furthermore, the display may receive input via the input device 58 before or after the displaying steps 88, 90. In addition, the input device 58 may itself be used as a switch to display either the first display 24 or the second display 26.

In this first type of embodiment, because the OLED display 12 of the portable computer 10 produces displays viewable from different surfaces depending on the open or closed position of the portable computer, a user can view the first display 24 when the computer is open and the second display 26 when the computer is closed. The first surface 20 is more convenient to view when the user is working with the computer 10 in an open position, as the user is typically positioned over the computer when working. The second surface 22 is more convenient to the user when the computer 10 is in the closed position, as the screen 14 of the portable computer blocks a substantial part of the remaining OLED display 12. Accordingly, the display 12 of this preferred type of embodiment allows a user to view and/or access more easily and conveniently the status icons 46 or the control icons 32 for operating the disk drive or other parts of the portable computer 10.

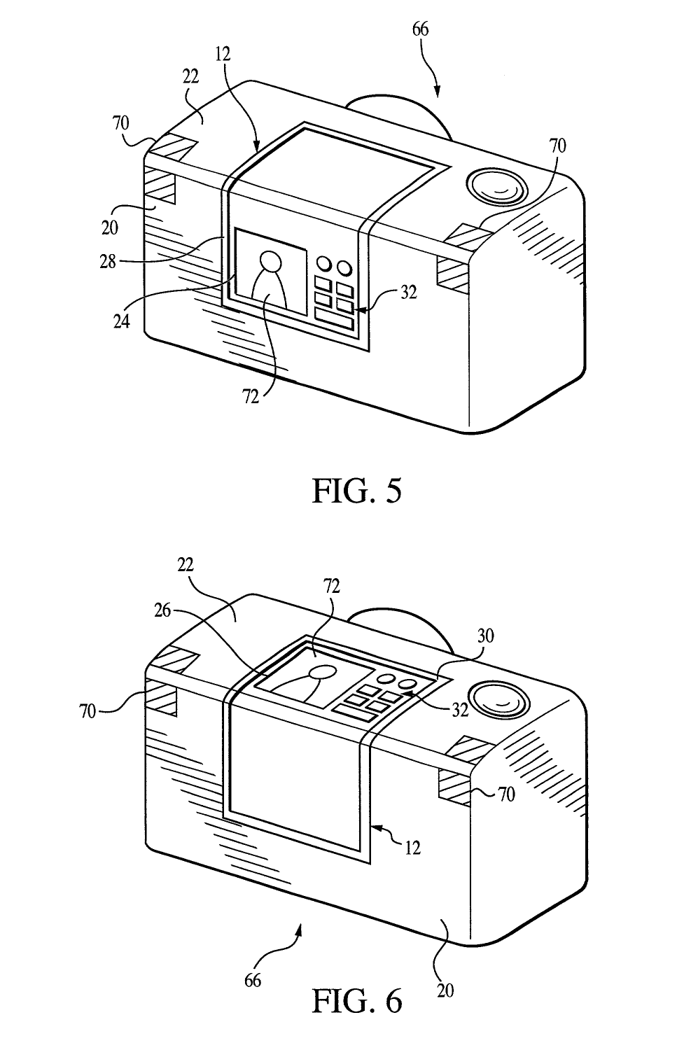

The OLED display 12 of the present invention may be used in various types of apparatuses. In addition, besides detecting open/closed positions or other positions based upon movement of a portion of an apparatus, certain embodiments of the display 12 may produce first or second displays 24, 26 in first or second surfaces 20, 22 depending on positions of the entire apparatus. FIGS. 5 and 6 show a camera 66 having the OLED display 12 according to a second preferred embodiment of the present invention, in which a detector 70 detects the relative location and/or the orientation of the camera to determine whether the first display 24 or the second display 26 is produced.

A user may move the camera 66 between first and second relative locations. For example, the user may move the camera 66 to an upper location for a horizontal shoot, and move the camera to a relatively lower location for a vertical shoot. The user may also tilt the camera 66 between a first orientation and a second orientation for a desired shot. For operation of the camera 66, the user may wish to view a display showing, for example, an image perceived by the lens of the camera, and/or access one or more controls. However, an image facing the user when the camera 66 is in an upper position, for example, may be difficult to view if the user moves the camera to a lower position for a vertical shoot. Similarly, an image on a surface facing the user in a first orientation may be difficult to view if the camera is tilted to a second orientation so that a different surface is facing the user.

The OLED display 12 in the camera 66 shown in FIGS. 5-6 is configured to produce the first display 24 (FIG. 5) viewable at the first (vertical, as shown in FIGS. 5 and 6) surface 20, and the second display 26 (FIG. 6) viewable at the second (horizontal, as shown) surface 22. The image shown in either surface preferably includes a viewfinder or view-screen image 72 and/or one or more of the control icons 32. OLED displays are typically well-suited for displaying images such as the view-screen image 72, with relatively sharp picture quality. The input device 58, such as a touch-sensitive membrane similar to that shown in FIG. 2, may overlay the OLED display 12, to receive feedback from a user for controlling the camera 66.

In one preferred embodiment, the detector 70 detects whether the camera 66 is in the relatively upper location or the lower location, and determines whether the OLED display 12 produces the first display 24 or the second display 26 (if both displays are shown simultaneously, peripheral effects of one display may confuse the viewer looking at the other display). Accordingly, if the user moves the camera 66 to a higher position, the OLED display 12 produces the first display 24, so that he or she can view the display with a substantially horizontal line of sight. If the user moves the camera 66 to a lower position, the OLED display 12 produces the second display 26, and the user can then view the display with a substantially vertical line of sight. The present invention further contemplates that a number of vertical (or horizontal) positions could be detected by the detector 70, and a corresponding number of displays could be produced by the OLED display 12 so that the OLED display appears to “shift” from the first surface 20 to the second surface 22 or vice versa as the user moves the camera 66.

A preferred embodiment of the detector 70 for detecting the relative location of the camera 66, as shown in FIGS. 5-6, includes one or more touch-sensitive pads disposed at or near a location or locations where a user would naturally grip the camera, preferably on a surface of the camera. In this embodiment, when the user naturally switches his or her grip, the OLED display 12 switches between producing the first display 24 or the second display 26 based on the locations of the pads that are contacted by the user. The detector 70 may also be a gravity-sensitive or motion-sensitive device, an optical device, a manually operated device, such as a switch, or other type of device. The detector 70 is coupled to the OLED display 12, either directly or indirectly, such as through the controller 64 of the type described previously, or of a different type.

In another preferred embodiment, the detector 70 detects whether the camera 66 is in a first orientation or a second orientation. This type of detector 70 may be a switch, a gravity-sensitive or motion-sensitive device, an optical device, or may include pads, such as those shown in FIGS. 5-6, so that when the user switches his or her grip, as may occur when the camera 66 is tilted from the first orientation to a second orientation, the OLED display 12 produces the first display 24 or the second display 26.

While specific embodiments of the present invention has been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

1. A display for an apparatus, the apparatus having a first surface in a first plane and a second surface in a second plane, the display comprising:
an OLED display capable of selectively producing either a first display viewable at the first surface or a second display viewable at the second surface; and
a detector for determining which of said first and said second display should be produced;
said OLED display responding to said detector to produce one of said first display or said second display.

2. The display according to claim 1 wherein said OLED display is disposed at least partly at said first surface and said second surface.

3. The display according to claim 1 wherein said detector determines whether the apparatus or a portion thereof is in a first position or a second position.

4. The display according to claim 1 wherein said detector determines an orientation of the apparatus.

5. The display according to claim 1 wherein said detector determines whether the apparatus or a portion thereof is in an open position or a closed position.

6. The display according to claim 1 wherein said detector determines whether the apparatus is in a first location or a second location.

7. The display according to claim 1 further comprising:
an input device for allowing a user to interface with the display.

8. The display according to claim 7 wherein said input device comprises a touch-sensitive membrane.

9. The display according to claim 8 wherein said touch-sensitive membrane is disposed at least partially over said OLED display.

10. The display according to claim 8 wherein said touch-sensitive membrane detects an input location.

11. The display according to claim 10 wherein said display compares said input location to a location of a portion of said first display or said second display.

12. The display according to claim 1 wherein said first display comprises an icon.

13. The display according to claim 12 wherein said second display comprises said icon.

14. The display according to claim 1 wherein said detector comprises at least one touch-sensitive pad.

15. The display according to claim 1 wherein said detector comprises a switch.

16. The display according to claim 1 wherein said detector comprises a motion-sensitive device.

17. The display according to claim 1 wherein said first display displays a first image and said second display displays said first image.

18. An apparatus comprising:
a housing having a first surface in a first plane and a second surface in a second plane;
an OLED display capable of selectively producing either a first display viewable at the first surface or a second display viewable at the second surface; and
a detector for determining which of said first and said second display should be produced;
said OLED display responding to said detector to produce one of said first display or said second display.

19. The apparatus according to claim 18 wherein said OLED display is at least partly disposed at said first surface and said second surface.

20. The apparatus according to claim 18 wherein said detector determines whether the apparatus or a portion thereof is in a first position or a second position.

21. The apparatus according to claim 18 further comprising:
an input device disposed at least partially over said OLED display.

22. The apparatus according to claim 21 wherein said input device comprises a touch-sensitive membrane.

23. The apparatus according to claim 21 wherein said input device detects an input location.

24. A method of producing a display for an apparatus, comprising the steps of:
providing an OLED display capable of producing a first display viewable from a first surface of the apparatus and a second display viewable from a second surface of the apparatus;
detecting a position of all or a portion of the apparatus; and
responsive to said position, producing either said first display or said second display.

25. The method according to claim 24 wherein said step of producing comprises producing said first display when a detector detects that said apparatus or a portion thereof is in a first position, and producing said second display when said detector detects that said apparatus or a portion thereof is in a second position.

26. A display for an apparatus, the apparatus having a first surface in a first plane and a second surface in a second plane, the display comprising:
an OLED display capable of selectively producing either a first display viewable at the first surface or a second display viewable at the second surface; and
means for detecting whether the apparatus or a portion thereof is in a first position or a second position;
said OLED display responding to said means for detecting to produce said first display if said means for detecting detects that the apparatus or a portion thereof is in said first position, and to produce said second display if said means for detecting detects that the apparatus or a portion thereof is in said second position.

27. The display according to claim 26 wherein said OLED display is disposed at least partly at said first surface and said second surface.

28. The display according to claim 26 further comprising:
touch-sensitive means for receiving input.

29. The display according to claim 28 wherein said means for receiving input is disposed at least partially over said OLED display.

30. The display according to claim 28 wherein said means for receiving input detects an input location.

31. The display according to claim 28 wherein said means for receiving input comprises a touch-sensitive membrane.

32. The display according to claim 26 wherein said means for detecting determines whether the apparatus or a portion thereof is in a first orientation or a second orientation.

33. The display according to claim 26 wherein said means for detecting determines whether the apparatus is in an open position or a closed position.

34. The display according to claim 26 wherein said means for detecting determines whether the apparatus is in a first location or a second location.

35. The display according to claim 26 wherein said means for detecting comprises a switch.

36. The display according to claim 26 wherein said means for detecting comprises a motion-sensitive device.

37. The display according to claim 26 wherein said means for detecting comprises at least one-touch sensitive pad disposed on a surface of the apparatus.
